(19) United States
(12) Patent Application Publication
(10) Pub. No.: US 2023/0311074 A1
(43) Pub. Date: Oct. 5, 2023

(54) REDOX MEMBRANES FOR LITHIUM EXTRACTION

(71) Applicant: XERION ADVANCED BATTERY CORP., Kettering, OH (US)

(72) Inventors: Heng Yang, Beavercreek, OH (US); Badri Shyam, Bexley, OH (US); John Busbee, Washington Township, OH (US); John Cook, Beavercreek, OH (US); Rodrigo Rodriguez, Centerville, OH (US)

(73) Assignee: XERION ADVANCED BATTERY CORP., Kettering, OH (US)

(21) Appl. No.: 18/194,563

(22) Filed: Mar. 31, 2023

Related U.S. Application Data
(60) Provisional application No. 63/325,830, filed on Mar. 31, 2022.

(51) Int. Cl. B01D 71/02; C25C 1/02; C25C 7/04; C25C 7/06; C25D 3/42; C25D 17/00; B01D 61/46; B01D 69/02

(52) U.S. Cl. CPC B01D 71/024; C25C 1/02; C25C 7/04; C25C 7/06; C25D 3/42; C25D 17/002; B01D 61/461; B01D 69/02; H01M 10/54

(57) ABSTRACT

An apparatus, system and redox membrane for efficient lithium-ion extraction from natural salt waters or geothermal brines or manmade sources such as from lithium battery recycling are provided. The redox membrane is selective for lithium ions over other spectator ions making the system capable of selectively extracting lithium-ions from multiple-ion source solutions. The system uses the redox membrane as an electrochemically active material acting as a Li-selective membrane for direct lithium extraction from a lithium-ion source. The redox membrane is also not porous to solvents and is stable in caustic and high temperature environments. The features of the redox membrane and system allow the recovery of lithium from low purity sources and the production of higher purity products at reduced costs and process steps over conventional processes.

### CROSS-REFERENCE TO RELATED APPLICATIONS

This application claims priority to, and the benefit of, U.S. provisional patent application Ser. No. 63/325,830 filed on Mar. 31, 2022, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

This technology pertains generally to ion extraction systems and methods and more particularly to electrochemically active redox membranes and systems that are capable of directly extracting lithium ions from an ion extraction source and producing high purity, Li-rich products.

### 2. Background

Lithium is an essential element in the production of lithium-ion batteries that have long life cycles and provide superior energy densities and high operating voltages over other types of batteries. Highly purified lithium compounds are also utilized for strong, light weight metal alloy production as well as in pharmaceuticals, biomedical applications, the synthesis of organic compounds and other industrial processes and products such as ceramics, specialty glass, synthetic rubber, dyes, and lubricating greases etc. These processes use lithium in various forms in addition to lithium metal including lithium carbonate, lithium hydroxide, lithium chloride, and butyl lithium.

The substantial increase in demand for lithium worldwide has spurred the need for improvements in processes of recovery from geological and recycling sources. These sources are generally found in either liquid or solid resources. The solid sources are mined mineral ores such as pegmatite, spodumene, lepidolite and petalite. Recycled batteries and electronic waste may also be a solid source of lithium.

Common liquid sources of lithium are typically salt lake brines, seawater, geothermal brines, desalinization plant and oilfield brines. The lithium-ion concentrations from these liquid sources can vary greatly from about (0.17 mg/L) in seawater to salt brines the range of about 100-1000 mg/L. These liquid sources may also include other common cations such as sodium (Na+), magnesium (Mg²⁺) and calcium (Ca²⁺) and anions such as chloride (Cl⁻), carbonate (CO₃²⁻) and sulfate (SO₄²⁻) that may complicate the extraction of Li from the brines.

Ion rich solutions such as salt waters or geothermal brines contain a mixture of cations and anions with orders of magnitude differences in concentrations. Currently, the extraction of individual cationic species into a purified product is a time intensive and multi-step process. In the case of solar brines solar evaporation is employed to reduce the water content of the ionic media which increases the concentration of the solutes. A series of separation techniques such as solvent extraction, ion precipitation, flotation, and filtration are employed to sequentially separate value-added products from the ionic media.

Ion absorbing media such as layered double hydroxides or electrochemically active materials that are capable of selectively extracting lithium-ions from multi-ion component aqueous solutions have also been developed. These separation techniques utilize a three-step operation to achieve ion segregation. In the first step, the absorbing media is exposed to a lithium-ion containing brine solution. Through chemical or electrochemical means, the lithium-ions are selectively absorbed by the media until saturation occurs. The second step removes the lithium-ion saturated media from the brine solution and a rinsing solution is employed to remove residual brine. In the final step, the lithium-ion saturated media is exposed to a pure aqueous solution where the lithium-ions are released (chemically or electrochemically), into the pure aqueous solution to yield a purified lithium product. This process is repeated indefinitely to continuously produce a purified lithium product. Though inherently a batch process, multiple absorbing media containing columns can be utilized such that lithium regeneration and absorption can occur simultaneously yielding a continuous process.

Other extraction methods utilize ion selective membranes to produce a high purity product. In the case of direct lithium-ion extraction, membrane technologies such as supported liquid membranes, nanofiltration membranes, and selective electrodialysis (utilizing ion exchanged membranes) have been explored in academic and pilot scale settings. These ion extracting membranes can typically demonstrate high selectivity to lithium ions and achieve greater than 80% recovery. Transport of ions through membranes is typically driven by a concentration or pressure gradient. Since this separation technology functions on lithium transport through the membrane layer rather than lithium-ion adsorption, which requires regeneration streams during operation, excessive waste streams can be avoided in some scenarios.

Accordingly, there is a need for new systems, devices and schemes to allow reliable extraction of lithium from liquid or solid sources that are efficient, scalable and has low energy requirements and reduced capital and operating costs.

### BRIEF SUMMARY

Systems and methods for lithium-ion extraction using a novel electrochemically active redox membrane that allows the production of products of high lithium purity and fluids with high ion concentrations as a feedstock for a variety of applications. The redox membrane can be adapted to extract Li ions from a variety of liquid ion extraction sources that may be natural, or man-made.

The present invention combines the functions of an ion-absorbing medium and a membrane to form an electrochemically active, redox membrane. Similar to a traditional membrane, the redox membrane is solvent-blocking but will allow the passage of certain ions. Permeability and selectivity of ions can be controlled by the redox couple in the membrane.

In the case of a lithium cobalt oxide (LiCoO₂) redox membrane, for example, the Co^{3/4+} couple can reversibly drive lithium ions into the redox membrane from one interface and release the lithium ions at the opposite interface. However, since the redox membrane is not capable of simultaneously absorbing and releasing ions, the redox membrane also functions as an ion absorbing material with sequential lithium uptake and release steps. The benefit of combining the membrane and absorbing media functionalities is the capability to directly produce a high purity lithium product from low purity lithium sources. In one embodiment, lithium extracted using the LCO redox membrane is converted to Li-containing products such as inorganic and organic lithium salts, pre-lithiated or lithium-containing battery materials and lithium metal.

LiCoO₂ (LCO) is a crystalline material that can be described using space group R3̅m (166). One preferred embodiment of the redox membrane is a LCO membrane with a crystal orientation in the (110) or (104) or (003) directions or a polycrystalline orientation or a combination of these orientations in the layered R3m space group. A LCO redox membrane with a crystal orientation in the (110) direction is particularly preferred due to facile ion transport properties compared to other crystallographic orientations.

In another embodiment, the redox membrane is made by growing a redox membrane on a substrate via a vapor phase deposition or in a molten salt electroplating bath and then removing the substrate and annealing the membrane to close off pores and yield a solvent-blocking material. In another embodiment, LCO powder is packed into a pellet and sintering to produce a solvent blocking redox membrane.

The ion extraction source can contain ions ranging from low concentrations to high concentrations (ppm level up to saturated solutions). The ion extraction source may also contain a number of additional dissolved solids such as bicarbonates, chlorides and nitrates of potassium, calcium and magnesium, silica and more. The ion extraction source may also be an aqueous, organic, or a molten salt solution. In one embodiment, the redox membranes are used for the selective extraction of lithium from batteries that may have or have not been previously used.

In one embodiment, the LCO material is used as a redox membrane to extract lithium from an aqueous lithium-containing solution. The aqueous solutions are electrolytes with dissolved LiCl, LiOH, Li₂CO₃, Li₂SO₄, or LiNO₃, LiBr, LiF, or LiI and combinations thereof. The aqueous solution can also contain other cation and anion species that the redox membrane is selective against.

In one embodiment, the LCO redox membranes are used for the extraction of lithium from lithium-containing solutions which are then transferred to pure water.

In another embodiment, the LCO redox membranes extract lithium ions from an aqueous solution and transfers it to an organic lithium-containing solution. Lithium metal is simultaneously plated on a metal substrate in the organic media. Alternatively, lithium extracted from the aqueous solutions can be plated through a solid electrolyte onto a metal substrate.

In one embodiment, the LCO redox membrane for lithium metal plating can be designed in a continuous R2R process. In this embodiment, a metal substrate is transferred into an organic lithium-containing electrolyte, plated with lithium metal and then transferred out of the electrolyte.

In another embodiment, LCO is used as a redox membrane to extract lithium from an aqueous lithium-containing solution. The LCO redox membrane extracts lithium ions from the aqueous solution and releases it into an organic lithium-containing electrolyte. Lithium is simultaneously deposited onto a lithium-ion battery anode material, which can be transferred in and out of the organic solution in either a batch or R2R process. In doing so, the lithium-ion battery anode is pre-lithiated with lithium, which enhances the performance of the lithium-ion battery.

In another embodiment, the metal substrate is laminated to a solid-state electrolyte. Lithium is plated in between the metal substrate (or current collector) and the solid electrolyte. In doing so, the lithium anode/solid electrolyte composite is formed in one deposition process.

In another embodiment, a solid electrolyte is coated on the redox membrane. A metal substrate is moved into contact with the redox membrane/solid electrolyte assembly. The redox membrane/solid electrolyte assembly can be shaped in different geometric formats to facilitate an intimate contact between the redox membrane and the solid-state electrolyte to provide uniform current distribution during electroplating.

The process of extracting lithium from saline ground waters is time intensive, requires many processing steps, and yields excessive waste streams. With a redox membrane, direct lithium extraction can be utilized to circumvent a large majority of the conventional processing steps required to achieve a pure lithium product from a lithium extraction source and thereby avoid the cost and energy required with these systems.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is schematic conceptual overview of the redox membrane-based system that allows the extraction of lithium ions from source of lithium ions such as brines according to one embodiment of the technology.

FIG. 2 is a schematic system diagram of a controlled extraction and release apparatus according to another embodiment of the technology.

FIG. 3 is a schematic top view of a scalable redox membrane platform according to another embodiment of the technology.

FIG. 4 is a functional block diagram of a method for lithium-ion extraction using a redox membrane platform according to one embodiment of the technology.

FIG. 5 is an XRD plot of electroplated lithium cobalt oxide on Al membrane demonstrating predominantly the (110) crystal plane orientation.

FIG. 6 is a plot of lithium extraction from a saturated lithium sulfate extraction source into the redox membrane 1 mAh of charge was passed at a rate of 2 mA cm⁻².

FIG. 7 is a plot of lithium release from a lithium cobalt oxide redox membrane into an aqueous LiOH product. 1 mAh of charge was passed at a rate of 2 mA cm⁻². A Pt foil counter electrode was used in both extraction and release.

FIG. 8 is a plot depicting a cyclic voltammetry curve with a lithium cobalt oxide redox membrane working electrode in a 1M lithium sulfate solution. A 5-mV scan speed with Pt wire and foil reference and counter electrode, respectively were used.

FIG. 9 is a schematic depiction of a molten salt bath and spontaneous lithium uptake from the bath using a redox membrane (Step 1) according to one embodiment of the technology.

FIG. 10 is a schematic depiction of lithium released into non-aqueous solution which directly produces Li metal via electrodeposition (Step 2).

### DETAILED DESCRIPTION

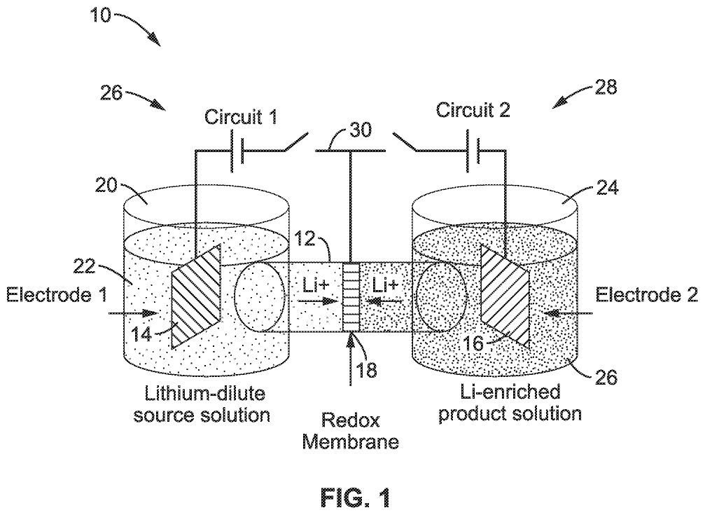

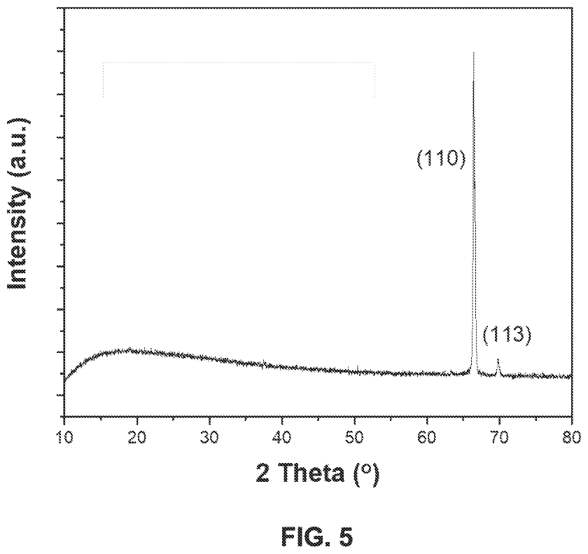

Referring more specifically to the drawings, for illustrative purposes, systems and methods for lithium-ion extraction and the fabrication and use of redox membranes are generally shown. Several embodiments of the technology are described generally in FIG. 1 to FIG. 10 to illustrate the characteristics and functionality of the devices, systems, materials and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, the general structure of one apparatus and system 10 for lithium extraction from liquid sources using a redox membrane is shown schematically. The apparatus of system 10 is a container 12 with first counter-current electrode such as an anode 14 and a second counter current electrode such as a cathode 16. The two counter current electrodes 14, 16 and redox membrane 18 are electrically coupled to a current source 28 (e.g., a current-applying galvanostat) with circuits to provide a controllable potential to the electrodes and membrane. The electrodes 14, 16 are preferably high surface area electrodes, typically carbon sheets, embedded with an efficient water-splitting electrocatalysts such as platinum or palladium nanoparticles.

The container 12 is separated into two compartments with a pore-free, redox membrane 18 wall. The redox membrane 18 is positioned to physically separate an ion extraction source and an ion poor solution such that the redox membrane is in contact with both solutions and actively prevents solution intermixing due to the dense nature of the redox membrane. In this illustration, the first compartment 20 has a source of solutions 22 of Li containing ions that are provided for extraction. The lithium containing solution for extraction can be an aqueous solution, an organic solution or a lithium-containing molten salt solution. For example, the solution 22 for extraction can be aqueous solutions or organic solutions are electrolytes with dissolved LiCl, LiOH, Li₂CO₃, Li₂SO₄, or LiNO₃ LiBr, LiF, or LiI and combinations thereof.

The second compartment 24 has a second solution 26. For example, the redox membranes can be used for the extraction of lithium from lithium-containing solutions 20 which are then transferred to pure water in the second compartment 24. However, the second solution 26 can also be an organic solution or a molten salt solution. For example, the system 10 can extract lithium ions from an aqueous solution 22 and transfer the ions to an organic lithium-containing solution 26. Lithium metal may be simultaneously plated on a metal substrate in the organic media. Alternatively, lithium extracted from the aqueous solutions can be plated through a solid electrolyte onto a metal substrate.

The redox membrane 18 is preferably ion selective in that the redox membrane is preferential to Li⁺ ions with high selectivity over Na, Mg, Ca, Al and Si ions. This feature is important as selectivity greatly determines the efficiency of the separation process and up-scaled system design. Highly selective membranes increase the efficiency by only allowing the main ion (in this case, Li⁺) to go through the membrane while actively blocking the movement of other ions (contaminant, spectator ions) that remain in the source liquid 22. The ion-selectivity also reduces the number of steps/stages in the plant required to separate out these undesirable ions and therefore, reduces capital expenses required by the system 10.

The second important feature of the redox membrane 18 is that it blocks the movement of solvents between compartments. The redox membranes 18 are pore-free monoliths that do not contain binder or carbon like traditional battery electrodes, which eliminates crossover from the lithium extraction source 22 to the final lithium product. This feature is important since it eliminates the need for rinsing the lithium extracting media between the lithium extracting and releasing steps. Thus, most of the waste streams are eliminated in the lithium extracting methods using the membrane.

The redox membrane 18 is also stable in caustic and high temperature environments. The redox membranes 18 are additive-free which eliminates the polymer binder stability issue experienced by conventional membranes known in the art. This enables the redox membrane to operate in a greater number of lithium extraction sources such as molten salts and geothermal brines at different temperatures.

The redox membrane 18 is also preferably a monolithic structure with crystal orientation that is tunable. In one embodiment, the lithium-diffusing channels in the redox membrane's material can be orientated orthogonally to the lithium extraction source/redox membrane interface in one compartment 22 and the lithium product/redox membrane interface in the other compartment 24. This enables the redox membrane 18 to achieve the highest possible lithium extraction throughput.

One method of preparing and operating a solvent blocking, free-standing, and electrochemically active redox membrane according to the technology begins with 1) Growing a redox membrane on a substrate via a vapor phase deposition or in a molten salt electroplating bath. In one embodiment, the redox membrane is grown on a two or three-dimensional metallic substrate such as aluminum, copper, steel, titanium, platinum, gold, silver, etc. In another embodiment, the redox membrane is grown on a two or three-dimensional carbon substrate. In another embodiment, the carbon substrate is coated or impregnated with a metal such as aluminum, copper, steel, titanium, platinum, gold, silver, etc.

2) Next, the substrate is removed from the deposited redox membrane to expose both sides of the membrane. For example, the substrate can be removed from the redox membrane via mechanical, laser, or chemical ablation.

3) Then, the redox membrane is annealed to close off pores and yield a solvent-blocking material. The resulting membrane is ready for use as a redox membrane in a separation and concentration apparatus, such as an H-Cell type of apparatus as illustrated in FIG. 1.

In another embodiment, the redox membrane is unsupported and fabricated via electrodeposition from a molten salt mixture and which may be either free-standing or supported in nature.

In a further embodiment, the redox membrane is supported in the form of an electronically conducting material such as a metal mesh or metal foam, or carbon-based materials such as a carbon felt, carbon foam, or porous carbons.

Alternatively, the LCO redox membrane may be fabricated as a dense, non-porous sintered oxide sheet (typically in the range of 10-500 microns) made from sintering LCO powder at temperatures >750° C. and high pressures (>10 MPa) and fabricated with or without a conducting scaffold or framework.

Generally, in a conventional H-cell test, the membrane separating the two solutions does not participate in the electrochemical reaction and the electrical circuit does not connect to the solvent-blocking membrane. In contrast, as shown in FIG. 1, during operation an electrical connection is made alternatively between the redox membrane 18 and each of the electrodes 14, 16 through a contact 30. Two open circuit elements are presented in this illustration to highlight the two-step, sequential operation of the H-cell structure fitted with a redox membrane. In the first step, the left-hand solution circuit (Circuit 1) is closed to establish an electrical connection with contact 30 while the right-hand connection of (Circuit 2) is kept open. An applied current in (Circuit 1) results in lithium-ion flow from the lithium-dilute source solution into the redox membrane. In the second step, the left-hand solution circuit (Circuit 1) is opened, and the right-hand circuit (Circuit 2) is closed. A spontaneous current can flow in (Circuit 2) which results in lithium-ion (i.e. Li release) from the redox membrane into lithium-enriched product solution. This two-step process can be carried out indefinitely to extract and produce a purified lithium product with high concentrations of Li (e.g., 20-30% LiOH solutions).

Functionally, the two-step process shown in FIG. 1 is applied sequentially during redox membrane operation. The first step involves ion uptake into the redox membrane 18 from the ion extraction source 22 in the first compartment 20. This is achieved by passing a current between the redox membrane 18 and an electrode 14. Using lithium cobalt oxide as the redox membrane material and a solution of Li₂SO₄ as the lithium extraction source as an example, the two half reactions forming the redox couple are shown below:
Redox Membrane Half-Reaction

Li₁₋ₓCoO₂+xe⁻+xLi⁺→LiCoO₂
Counter Electrode Half-Reaction

x/2H₂O→xe⁻+xH⁺+x/4O₂

These half reactions proceed until the redox membrane 18 becomes saturated or partially filled with lithium. Using LiOH as the lithium product of interest in this example, lithium release into its product form occurs by passing a current between the redox membrane 18 and another electrode 16 in the second solution 26. The redox couple for these half reactions are shown below:
Redox Membrane Half-Reactions

LiCoO₂→Li₁₋ₓCoO₂+xe⁻+xLi⁺

Cl⁻→Cl₂(g)+xe⁻
Counter Electrode Half-Reactions

x/4O₂+x/4H₂O+xe⁻→xOH⁻

Li⁺+OH⁻+H₂O→LiOH·H₂O(aq.)

These half reactions proceed until the redox membrane 18 becomes lithium-ion depleted. During operation of the redox membrane 18, the lithium uptake and lithium release electrochemical steps occur sequentially and indefinitely. Thus, the direct lithium extraction method in this illustration can extract lithium from various types of lithium containing solutions, with no additional processing steps, and produce a higher-grade lithium product (i.e. with higher Li content than is present in the ion extraction source).

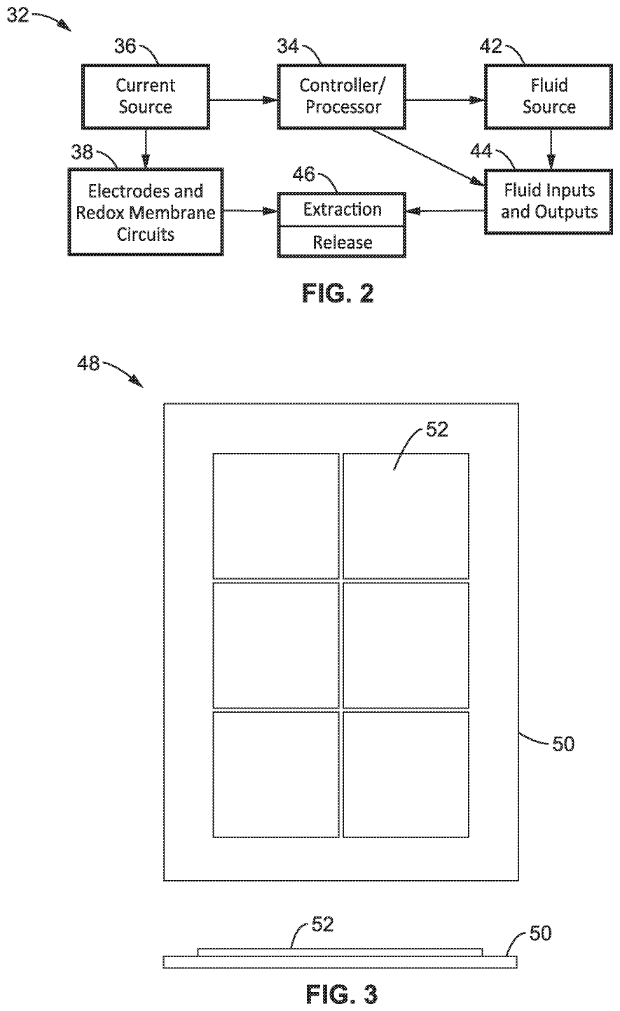

A system extracting lithium from liquid lithium solutions using controlled processes is shown schematically in FIG. 2. The system provides control functions with a controller or processor with software 34. The controller/processor 34 is electrically coupled to current source 36 and the electrodes and membrane contacts through circuits 38. The controller/processor 34 is configured to control the actuation, duration and characteristics of output of current source, electrodes and redox membrane of the extraction and release apparatus 46.

The controller/processor 34 also controls the dispensing or removal of solution sources 42 to the compartments of the apparatus 46 through controllable solution inputs and outputs 44 in this embodiment.

In one embodiment, a large-scale electrode 48 design for increased process throughput is shown in FIG. 3. The design consists of an electrically conducting frame 50 which can be filled with multiple redox membranes 52 of smaller area. Several of these larger electrodes can then be stacked in series for processing high volumes of Li-containing feed solutions to produce product solutions enriched in Li concentration. This large-scale electrode 48 design provides improved process throughput (i.e., processing volumes). Pore-free redox membrane slabs 52, such as lithium cobalt oxide, are fabricated to fit into the redox-membrane insertion sites and the perimeter of the membranes and the electrode frame will be sealed to yield a large format, leak-free redox membrane. Like the operation of a single redox membrane slab, a lithium-dilute source solution would flow parallel on one side of the large-format redox membranes. The lithium-enriched product solution would flow on the other side of the large-format membranes.

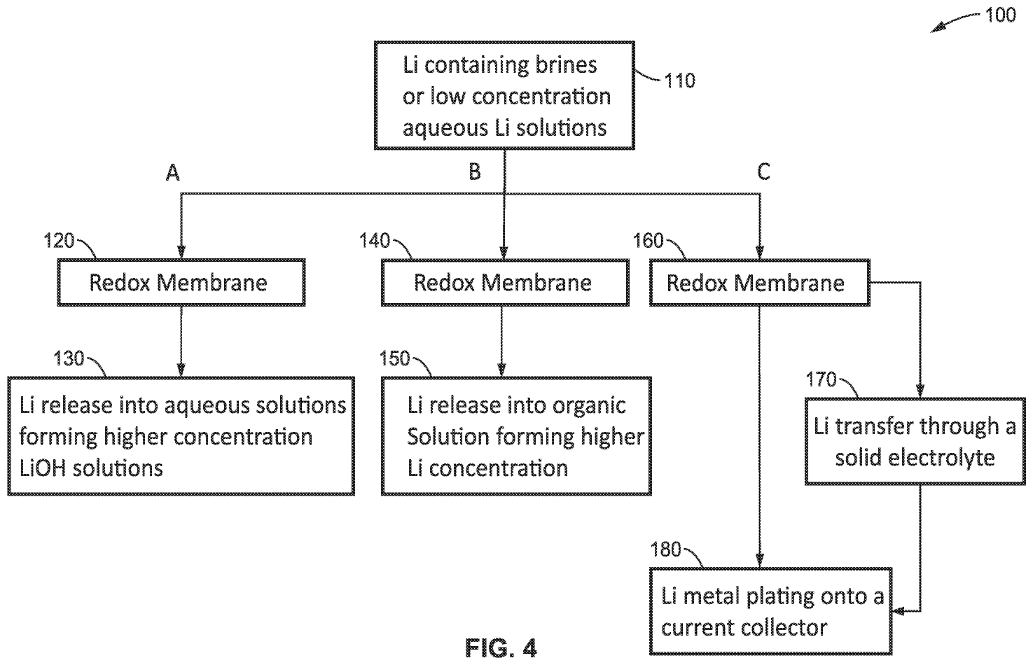

Turning now to FIG. 4, a functional block diagram of three related methods (A, B and C) 100 for membrane mediated lithium-ion extraction from liquid sources that release to an aqueous, organic or solid electrolyte media are generally shown. At block 110, solutions of lithium containing brines or aqueous lithium solutions of various available concentrations are provided. The lithium-ion source material provided at block 110 can come from solvated ore, recycling of battery materials or natural lithium brine sources and the like.

Lithium ions are generally extracted at block 120 from the lithium source that was acquired at block 110 with the redox membrane as illustrated in the first set of half reactions above and Circuit 1 of FIG. 1.

The membrane extracted lithium at block 120 is then released from the redox membrane into a second aqueous solution at block 130 as illustrated in the second set of half reactions above and the application of Circuit 2 of FIG. 1. The lithium is released in the form of LiOH into the second solution in this illustration. In one embodiment, the second solution can be pure water or an existing solution containing LiOH, for example.

In an alternative method B shown in FIG. 4, lithium is similarly extracted from the lithium source acquired at block 110 with the redox membrane at block 140. However, the lithium from the membrane is released at block 150 into an organic solution to increase the lithium in the organic solution rather than an aqueous solution using Circuit 2 of FIG. 1. The concentrated organic or aqueous solutions can be processed further to provide other desirable lithium containing molecules. For example, recovered lithium may be converted to Li-containing products such as inorganic and organic lithium salts, pre-lithiated or lithium-containing battery materials and lithium metal. In one embodiment, lithium metal is simultaneously plated on a metal substrate in the organic media.

In another alternative method C, shown in FIG. 4, lithium is extracted from the source material at block 160 with the redox membrane. The extracted lithium is transferred through a solid electrolyte at block 170 and thereafter lithium is plated onto a current collector at block 180. Accordingly, lithium extracted from an aqueous solution or brine can ultimately be plated through a solid electrolyte onto a metal substrate in this embodiment.

In another embodiment of method C, the LCO redox membrane for lithium metal plating can be designed in a continuous R2R process. For example, a metal substrate may be transferred into an organic lithium-containing electrolyte produced at block 170 and plated with lithium metal and then transferred out of the electrolyte at block 180.

In another example, the metal substrate may be laminated to a solid-state electrolyte. Lithium is then plated in-between the metal substrate and the solid electrolyte forming a lithium anode/solid electrolyte composite in one deposition process.

Alternatively, a solid electrolyte may be coated onto the redox membrane. A metal substrate is then moved into contact with the redox membrane/solid electrolyte assembly. The redox membrane/solid electrolyte assembly can be shaped in different geometric formats to facilitate an intimate contact between the redox membrane and the solid-state electrolyte to provide uniform current distribution during electroplating.

The plating method can also be adapted to enhance the performance of lithium-ion batteries by pre-lithiating the anodes with lithium. For example, an LCO redox membrane is used to extract lithium from an aqueous lithium-containing solution and release it into an organic lithium-containing electrolyte. Lithium is simultaneously deposited onto a lithium-ion battery anode material, which can be transferred in and out of the organic solution in either a batch or R2R process.

Accordingly, a stable, ion selective, solvent blocking redox membrane structure and methods of use are provided. The redox membrane features allow the extraction from lithium extraction sources such as molten salts and geothermal brines with the high lithium extraction throughput and less cost compared with conventional extraction methods.

The technology described herein may be better understood with reference to the accompanying examples, which are intended for purposes of illustration only and should not be construed as in any sense limiting the scope of the technology described herein as defined in the claims appended hereto.

### Example 1

In order to demonstrate the operational principles of the technology, LCO lithium-ion extraction redox membranes were fabricated and tested. In this illustration, lithium cobalt oxide (LiCoO₂) was produced by electrodeposition on an electrode and evaluated.

A mixture of 0.75 g LiOH and 8 g KOH was ground and placed into a nickel crucible. After heating to 350° C., about 0.5 g CoO was added to the melt. The melt color changed from white to blue as the divalent cobalt ion was coordinated by hydroxide ions. After the added CoO was totally dissolved, aluminum foil was inserted into the bath for LiCoO₂ deposition.

For the pure (110) orientation, 20 mA/cm² pulses were applied for 2 seconds, with 5 seconds rest between pulses. An electrode with a loading of 4 mAh/cm² and a thickness of 60 μm was produced when 700 on/off cycles are used. Higher loading samples (120 μm and 240 μm) were produced by increasing the number of pulses to 1,400, and 2,800, respectively.

XRD of electroplated lithium cobalt oxide on Al was performed and FIG. illustrates the predominantly the (110) crystal plane orientation which is the fast Li-ion diffusion direction.

An H-type electrochemical cell was used with the prepared LCO redox membrane to demonstrate and test the capacity for Li separations. The H-cell was assembled using a (110) faceted LCO redox membrane which physically separated two solutions. One solution was filled with a saturated solution of Li₂SO₄ and the other solution contained 0.1 M LiOH. Platinum foil and platinum wire were used as the reference and counter electrode, respectively. 2 mA cm⁻² of current density was passed through the LCO redox membrane to absorb lithium from the Li₂SO₄ solution (a) and release lithium into the LiOH solution (b).

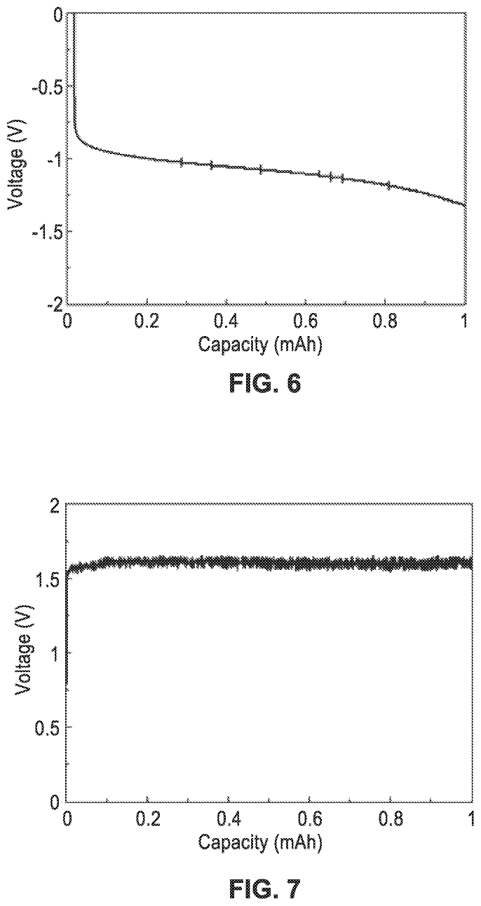

Lithium extraction from a saturated lithium sulfate extraction source into the redox membrane is shown in FIG. 6 and the lithium release from a lithium cobalt oxide redox membrane into an aqueous LiOH product is shown in FIG. 7. Thereafter, 1 mAh of charge was passed at a rate of 2 mA cm⁻². A Pt foil counter electrode was used in both extraction and release.

### Example 2

As another illustration, electrochemical data was obtained using a second H-type cell. The H-cell was assembled using a (110) faceted LCO redox membrane which physically separated two solutions. One solution was filled with a saturated solution of Li₂SO₄ and the other solution contained 0.1 M LiOH. Platinum foil and platinum wire were used as the reference and counter electrode, respectively. A 5-mV scan speed was used to sweep the voltage from −2 to 2 volts, with the scan sweep initiating in the positive voltage direction. The oxidation/reduction peak currents for the LCO redox membrane can be seen near the 1-volt line.

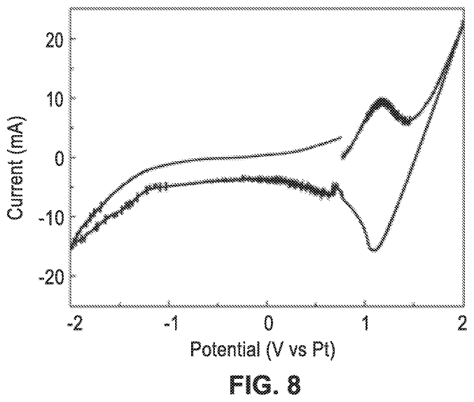

Cyclic voltammetry curve with a lithium cobalt oxide redox membrane working electrode in a 1M lithium sulfate solution in compartment (a) with a 5-mV scan speed with Pt wire and foil reference and counter electrode, respectively is shown in FIG. 8.

### Example 3

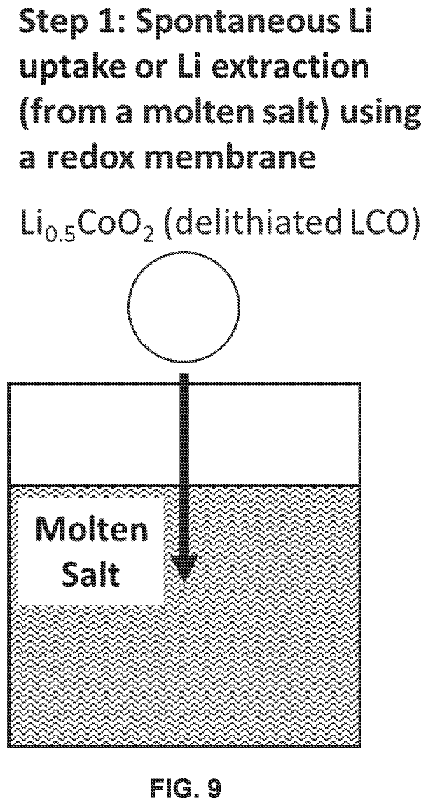

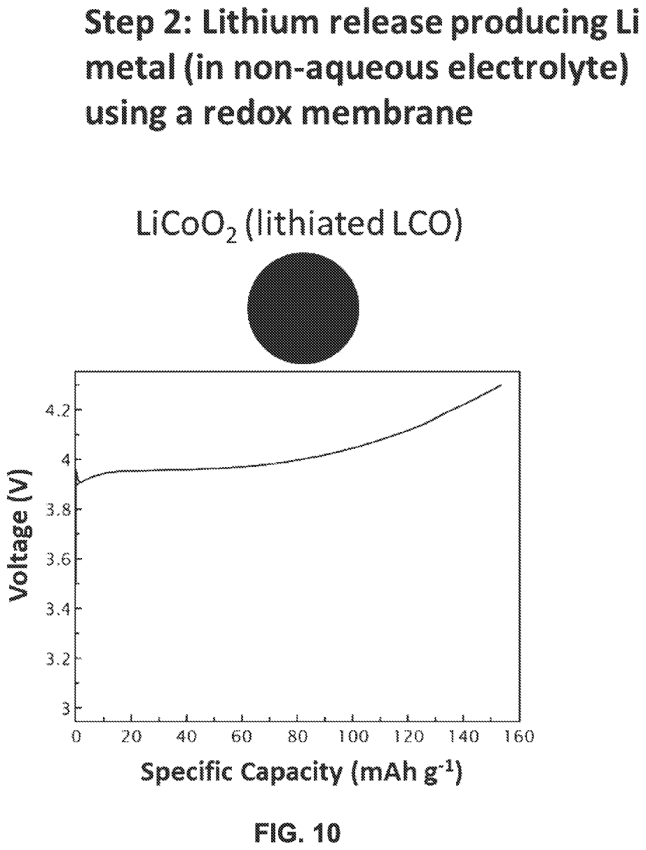

To further demonstrate the capabilities of the redox membrane and separation technology, LCO lithium-ion extraction redox membranes were fabricated and tested in the context of a molten salt bath separation. In this illustration, lithium metal was electrodeposited in a two-step process. Step 1 that is illustrated in FIG. 9 shows lithium uptake from a molten salt bath and Step 2 shown in FIG. 10 illustrates the lithium release into a non-aqueous solution which directly produces Li metal via electrodeposition.

In Step 1, LCO on Al electrodes were prepared using a molten salt electroplating system. These LCO on Al electrodes were punched into circular discs and assembled in CR 2025-coin cells with a polymer separator, liquid organic electrolyte, and Li chip counter/reference electrode. A potentiostat was then utilized to delithiate the LCO from the LiCoO₂ pristine condition to the Li_{0.5}CoO₂ state. The lithium depleted, Li_{0.5}CoO₂ electrodes were then submerged in a lithium-containing molten salt bath (Step 1) for ten minutes.

After ten minutes, the submerged LCO electrodes were removed from the molten salt, cleaned, and reassembled in new CR 2025-coin cells with polymer separator, liquid organic electrolyte, and Li chip counter/reference electrodes. Delithiation of this molten salt treated LCO in the CR 2025-coin cells demonstrated that the originally delithiated LCO had spontaneously relithiated in the molten salt system (Step 2).

From the description herein, it will be appreciated that the present disclosure encompasses multiple embodiments which include, but are not limited to, the following:

A polymer free redox membrane composition for lithium extractions, comprising: (a) a plate of non-porous, electrochemically active lithium transition metal oxide; (b) wherein the plate is impermeable to solvents; (c) wherein the plate is configured to preferentially select lithium ions over other ions; and (d) wherein the plate is active and stable at room temperature, 20-30° C., but also active and stable at elevated temperatures between 60° C. to 200° C.

The composition of any preceding or following implementation, wherein the redox membrane comprises a plate of LiCoO₂ (LCO).

The composition of any preceding or following implementation, wherein the LCO redox membrane comprises a membrane of sintered packed LCO powder.

The composition of any preceding or following implementation, wherein the LCO redox membrane comprises a membrane with a (110) crystalline orientation in a layered R3-m space group.

The composition of any preceding or following implementation, the plate further comprising at least one electrical contact coupled to the plate.

An apparatus for lithium-ion extraction, the apparatus comprising: (a) a redox membrane with a first active surface on a first side and a second active surface on a second side and one or more electrical contacts; (b) a container with an interior separated into first and second compartments by the redox membrane; (c) at least one electrode within the first compartment and at least one counter electrode in the second compartment of the container; and (d) a current source electrically coupled to the electrodes and the redox membrane.

The apparatus of any preceding or following implementation, further comprising: a controller with electrical circuits electrically coupled to the current source, electrodes and redox membrane; wherein the controller is configured to control actuation, duration and characteristics of current applied to the electrodes and redox membrane.

The apparatus of any preceding or following implementation, further comprising: one or more solution inputs fluidly coupled to at least one solution source and to at least one of the compartments of the container; and one or more solution outputs fluidly coupled to at least one compartment of the container; wherein solutions can be introduced to at least one compartment through the inputs; and wherein solutions can be withdrawn from at least one compartment through the outputs.

The apparatus of any preceding or following implementation, further comprising: a controller operably coupled to the fluid inputs and outputs, the controller configured to control entry and exit of a first solution and a second solution through the fluid inputs and outputs into the compartments.

The apparatus of any preceding or following implementation, wherein the LCO redox membrane selects Li ions over one or more positively charged ions (cations) of the group of Na+, Mn²⁺, Mg²⁺, Ca²⁺, Zn²⁺, Sr²⁺, Ba²⁺, Al³⁺ and Si⁴⁺ ions.

The apparatus of any preceding or following implementation, wherein the LCO redox membrane selects Li ions in the presence of one or more negatively charged ions (anions) of the group of Cl⁻, Br⁻ and SO₄⁻².

The apparatus of any preceding or following implementation, further comprising a membrane current collector slab coupled to a current source; and a plurality of redox membranes electrically coupled to the slab in series or in parallel to enable greater throughput or solution volume processed.

A method for extracting lithium from a liquid source, the method comprising: (a) providing a first solution of one or more lithium containing salts; (b) extracting Li ions from the solution with an LCO redox membrane; and (c) releasing the extracted Li ions from the LCO redox membrane into a second solution.

The method of any preceding or following implementation, further comprising converting lithium ions released to the second solution to a product selected from the group of an inorganic lithium salt, an organic lithium salt and lithium metal.

The method of any preceding or following implementation, wherein the first solution of lithium containing salts comprises one or more salts selected from the group of LiCl, LiOH, Li₂CO₃, Li₂SO₄, LiNO₃, LiBr, LiF, and LiI.

The method of any preceding or following implementation, wherein the first solution of lithium containing salts comprises a Li-ion containing organic solution.

The method of any preceding or following implementation, wherein the first solution of lithium containing salts comprises an aqueous solution and the second solution comprises an organic solution.

The method of any preceding or following implementation, further comprising placing a metal substrate into the second solution; and plating lithium metal onto the substrate.

A system extracting lithium from liquid lithium solutions, comprising: (a) a separation apparatus, comprising: (i) one or more redox membrane with a first active surface on a first side and a second active surface on a second side and one or more electrical contacts; (ii) a container with an interior separated into two compartments by each the redox membrane; (iii) at least one electrode within one compartment and at least one counter electrode in the other compartment of the container; and (iv) a current source electrically coupled to the electrodes and the redox membranes; (b) a processor configured to control the current source, electrodes and redox membranes; and (c) a non-transitory memory storing instructions executable by the processor; (d) wherein the instructions, when executed by the processor, perform steps comprising: (i) providing a solution of one or more lithium containing salts; (ii) extracting Li ions from the solution with the one or more redox membranes; and (iii) releasing the extracted Li ions from the one or more redox membranes into a second solution; and (e) processing the released Li ions from the second solution.

The system of any preceding or following implementation, wherein the processing of released Li ions comprises converting lithium ions released to the second solution to a product selected from the group of an inorganic lithium salt, an organic lithium salt and lithium metal.

The system of any preceding or following implementation, wherein the processor and instructions are configured to control actuation, duration and characteristics of current applied to the electrodes and one or more redox membranes.

The system of any preceding or following implementation, wherein the redox membrane of the apparatus of the system comprises a plate of LiCoO₂ (LCO).

As used herein, term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A polymer free redox membrane composition for lithium extractions, comprising:
(a) a plate of non-porous, electrochemically active lithium transition metal oxide;
(b) wherein said plate is impermeable to solvents;
(c) wherein said plate is configured to preferentially select lithium ions over other ions; and
(d) wherein the plate is active and stable at room temperature, 20-30° C., but also active and stable at elevated temperatures between 60° C. to 200° C.

2. The composition of claim 1, wherein said redox membrane comprises a plate of LiCoO₂ (LCO).

3. The composition of claim 2, wherein said LCO redox membrane comprises a membrane of sintered packed LCO powder.

4. The composition of claim 2, wherein said LCO redox membrane comprises a membrane with a (110) crystalline orientation in a layered R3-m space group.

5. The composition of claim 1, said plate further comprising at least one electrical contact coupled to the plate.

6. An apparatus for lithium-ion extraction, the apparatus comprising:
(a) a redox membrane with a first active surface on a first side and a second active surface on a second side and one or more electrical contacts;
(b) a container with an interior separated into first and second compartments by said redox membrane;
(c) at least one electrode within the first compartment and at least one counter electrode in the second compartment of the container; and
(d) a current source electrically coupled to said electrodes and said redox membrane.

7. The apparatus of claim 6, further comprising:
a controller with electrical circuits electrically coupled to the current source, electrodes and redox membrane;
wherein said controller is configured to control actuation, duration and characteristics of current applied to the electrodes and redox membrane.

8. The apparatus of claim 6, further comprising:
one or more solution inputs fluidly coupled to at least one solution source and to at least one of the compartments of the container; and
one or more solution outputs fluidly coupled to at least one compartment of the container;
wherein solutions can be introduced to at least one compartment through the inputs; and
wherein solutions can be withdrawn from at least one compartment through the outputs.

9. The apparatus of claim 8, further comprising:
a controller operably coupled to said fluid inputs and outputs, said controller configured to control entry and exit of a first solution and a second solution through said fluid inputs and outputs into the compartments.

10. The apparatus of claim 6, wherein said LCO redox membrane selects Li ions over one or more positively charged ions (cations) of the group of Na+, Mn²⁺, Mg²⁺, Ca²⁺, Zn²⁺, Sr²⁺, Ba²⁺, Al³⁺ and Si⁴⁺ ions.

11. The apparatus of claim 6, wherein said LCO redox membrane selects Li ions in the presence of one or more negatively charged ions (anions) of the group of Cl⁻, Br⁻ and SO₄²⁻.

12. The apparatus of claim 6, further comprising:
a membrane current collector slab coupled to a current source; and
a plurality of redox membranes electrically coupled to the slab in series or in parallel to enable greater throughput or solution volume processed.

13. A method for extracting lithium from a liquid source, the method comprising:
(a) providing a first solution of one or more lithium containing salts;
(b) extracting Li ions from the solution with an LCO redox membrane; and
(c) releasing the extracted Li ions from the LCO redox membrane into a second solution.

14. The method of claim 13, further comprising:
converting lithium ions released to the second solution to a product selected from the group of an inorganic lithium salt, an organic lithium salt and lithium metal.

15. The method of claim 13, wherein said first solution of lithium containing salts comprises one or more salts selected from the group of LiCl, LiOH, Li₂CO₃, Li₂SO₄, LiNO₃, LiBr, LiF, and LiI.

16. The method of claim 13, wherein said first solution of lithium containing salts comprises a Li-ion containing organic solution.

17. The method of claim 13, wherein said first solution of lithium containing salts comprises an aqueous solution and the second solution comprises an organic solution.

18. The method of claim 13, further comprising:
placing a metal substrate into the second solution; and
plating lithium metal onto the substrate.

19. A system extracting lithium from liquid lithium solutions, comprising:
(a) a separation apparatus, comprising:
(i) one or more redox membrane with a first active surface on a first side and a second active surface on a second side and one or more electrical contacts;
(ii) a container with an interior separated into two compartments by each said redox membrane;
(iii) at least one electrode within one compartment and at least one counter electrode in the other compartment of the container; and
(iv) a current source electrically coupled to said electrodes and said redox membranes;
(b) a processor configured to control the current source, electrodes and redox membranes; and
(c) a non-transitory memory storing instructions executable by the processor;
(d) wherein said instructions, when executed by the processor, perform steps comprising:
(i) providing a solution of one or more lithium containing salts;
(ii) extracting Li ions from the solution with the one or more redox membranes; and
(iii) releasing the extracted Li ions from the one or more redox membranes into a second solution; and
(e) processing the released Li ions from the second solution.

20. The system of claim 19, wherein said processing of released Li ions comprises:
converting lithium ions released to the second solution to a product selected from the group of an inorganic lithium salt, an organic lithium salt and lithium metal.

21. The system of claim 19, wherein said processor and instructions are configured to control actuation, duration and characteristics of current applied to the electrodes and one or more redox membranes.

22. The system of claim 19, wherein said redox membrane of said apparatus of said system comprises a plate of LiCoO₂ (LCO).
